(19) United States
(12) Patent Application Publication
(10) Pub. No.: US 2017/0183585 A1
(43) Pub. Date: Jun. 29, 2017

(54) GASIFICATION UNIT, INTEGRATED GASIFICATION COMBINED CYCLE FACILITY, AND METHOD FOR STARTING GASIFICATION UNIT

(71) Applicant: MITSUBISHI HITACHI POWER SYSTEMS, LTD., Yokohama (JP)

(72) Inventors: Shogo YOSHIDA, Yokohama (JP); Yoshinori KOYAMA, Tokyo (JP); Toshiyuki YAMASHITA, Tokyo (JP)

(21) Appl. No.: 15/312,915

(22) PCT Filed: Jul. 2, 2015
(86) PCT No.: PCT/JP2015/069181

§ 371 Date: Nov. 21, 2016

(30) Foreign Application Priority Data
Jul. 9, 2014 (JP) 2014-141217

(51) Int. Cl. C10J 3/72; F02C 3/28; F01K 11/02; F01K 7/16; F01K 23/10; F01D 15/10; F02C 3/04; F02C 6/18

(52) U.S. Cl. CPC C10J 3/723; C10J 3/726; F02C 3/04; F02C 3/28; F02C 6/18; F01K 7/16; F01K 23/10; F01D 15/10; F01K 11/02; C10J 2300/1223; C10J 2300/1653; C10J 2300/0959; C10J 2300/093; F05D 2220/32; F05D 2220/72; F05D 2220/76; F05D 2240/35

(57) ABSTRACT

There is provided coal gasification unit including: a coal gasifier; a char recovery unit; flare equipment; an air flow rate adjustment valve and an oxygen supply flow passage that supply oxygen-containing gas to the coal gasifier; an inert gas supply flow passage that supplies nitrogen gas to an upstream side of the char recovery unit; and a control unit that controls a supply amount of the oxygen-containing gas and a supply amount of the nitrogen gas, in which the coal gasifier has a starting burner, and in which the control unit controls the supply amount of the nitrogen gas prior to starting combustion of starting fuel by the starting burner so that an oxygen concentration of mixed gas in which combustion gas generated by combustion of the oxygen-containing gas and the starting fuel has been mixed with the nitrogen gas becomes not more than an ignition concentration.

### TECHNICAL FIELD

The present invention relates to gasification unit, an integrated gasification combined cycle facility, and a method for starting the gasification unit.

### BACKGROUND ART

An integrated coal gasification combined cycle (IGCC) facility is a power-generation facility that aims at higher efficiency and higher environmental friendliness compared with conventional coal-fired thermal power by gasifying coal, which is solid carbonaceous fuel, and combining it with combined cycle power generation. The integrated gasification combined cycle facility also has a large advantage of being able to utilize coal having an abundant resource amount, and it has been known to have a larger advantage by extending applicable coal types.

A conventional integrated gasification combined cycle facility is generally configured to include: a coal supply device; a coal gasifier; a char recovery unit; gas purification equipment; gas turbine equipment; steam turbine equipment; and an exhaust heat recovery boiler. Accordingly, coal (pulverized coal) is supplied to the coal gasifier by the coal supply device, and a gasifying agent (an air, an oxygen-enriched air, oxygen, steam, or the like) is taken in.

In the coal gasifier, coal is gasified, and combustible gas (coal gasification gas) is generated. The generated combustible gas is then purified after unreacted coal (char) is removed in the char recovery unit, and after that, the purified combustible gas is supplied to the gas turbine equipment.

The combustible gas supplied to the gas turbine equipment generates high-temperature and high-pressure combustion gas by being burned in a combustor as fuel, and a gas turbine of the gas turbine equipment is driven by the supply of the combustion gas.

Heat energy is recovered by the exhaust heat recovery boiler from exhaust gas discharged after the gas turbine is driven, and steam is generated. The steam is supplied to the steam turbine equipment, and a steam turbine is driven by the steam. Accordingly, power generation can be performed by a generator using the gas turbine and the steam turbine as drive sources.

Meanwhile, the exhaust gas whose heat energy has been recovered by the exhaust heat recovery boiler is emitted to the atmosphere through a chimney.

In the above-mentioned integrated gasification combined cycle facility, a starting process of the coal gasifier includes steps (1) to (9) shown below.

Namely, the general starting process of the coal gasifier is carried out in order of: (1) nitrogen gas purge; (2) pressurization/warming of an inside of the gasifier; (3) gasifier ignition by air aeration and starting fuel; (4) gas supply to a porous filter; (5) ramping (pressurization); (6) passing gas through the gas purification equipment; (7) switching of gasifier fuel; (8) switching of gas turbine fuel; and (9) rise of a load.

Note that although the above-mentioned process is a case of air-blown gasification, steps (1) to (7) of the above-mentioned process are common also in a case of a chemical synthetic plant by oxygen-blown gasification.

In such a starting process, as the starting fuel used at the time of the gasifier ignition of step (3), for example, kerosene and light oil, natural gas, etc. can be exemplified.

In addition, in step (8) of switching of the gas turbine fuel, the gas turbine fuel is changed to coal gas generated in the gasifier from the starting fuel (for example, kerosene, light oil, natural gas, etc.) used at the time of start when the coal gas cannot be supplied.

PTL 1 describes that warming of a gasifier and a gas purification device is performed while exhaust gas is burned in a flare stack (flare equipment) until conditions become the ones in which gas composition and a pressure are stabilized, and in which gas can be burned by a gas turbine, at the time of start of an integrated gasification combined cycle facility. Additionally, it also describes that a flue gas treatment device for the flare stack is needed at a location point strict in environmental conditions.

In addition, PTL 2 discloses a coal gasification plant in which a bypass line that branches on an upstream side of a dust removal device to reach a flare stack has been provided in a main system line that couples a coal gasifier and the dust removal device.

### CITATION LIST

### Patent Literature

### {PTL 1}

Japanese Unexamined Patent Application, Publication No. Sho 62-182443

### {PTL 2}

Japanese Unexamined Patent Application, Publication No. 2006-152081

### SUMMARY OF INVENTION

### Technical Problem

By the way, since nitrogen gas is passed through during steps (1) to (2) in the above-mentioned starting process, for example, oxygen (O₂) is hardly contained in nitrogen gas of purity 99 vol %. However, at the time of gasifier ignition by the air aeration and the starting fuel of step (3), combustion exhaust gas containing air and remaining oxygen (hereinafter also referred to as “oxygen-containing gas”) is generated at least at the beginning of the step.

Note that a reason why a phrase “at least at the beginning of the step” is used is that gas hardly containing oxygen is passed through the porous filter again after step (4).

When the air and the combustion exhaust gas are passed through the porous filter for dust removal, and unburned coal (hereinafter it is called “char”) present in a filter element is burned, combustion heat generated by the burning of the char causes excessive rise of a filter element temperature.

Since the excessive rise of the filter element temperature as described above causes design temperature excess and damage of a material, it is necessary at least to bypass the porous filter to thereby treat the gas in a flare system at the beginning of gasifier ignition by the air aeration and the starting fuel. Note that a general bypass flow passage is, for example, as disclosed in PTL 2, branched on an upstream side of a cyclone inlet in a piping flow passage that couples between a gasifier outlet and a cyclone.

However, in step of gasifier ignition by the air aeration and the starting fuel by the above-mentioned system (process), soot and dust (char) that remain(s) in the gasifier and a piping are contained in treatment gas treated in the flare equipment, although temporarily. Containing of the char as described above is not preferable even if temporarily, and the char is desirably suppressed from being temporarily contained in the treatment gas from the flare equipment at the time of start of the gasifier.

The present invention has been made to solve the above-described problems, and an object thereof is to provide gasification unit in which ignition of unburned solid carbonaceous fuel contained in char present in a char recovery unit has been suppressed while gas containing the char is suppressed from being supplied to flare equipment when the gasification unit is started, an integrated gasification combined cycle facility including the gasification unit, and a method for starting the gasification unit.

### Solution to Problem

The present invention has employed the following solutions in order to solve the above-described problems.

Gasification unit according to one aspect of the present invention includes: a gasifier that gasifies solid carbonaceous fuel using oxygen-containing gas, and generates combustible gas; a char recovery unit that recovers char contained in the combustible gas generated by the gasifier; flare equipment that burns the combustible gas from which the char has been recovered by the char recovery unit; a first supply section that supplies the oxygen-containing gas to the gasifier; a second supply section that supplies inert gas to an upstream side of the char recovery unit; and a control section that controls a supply amount of the oxygen-containing gas supplied by the first supply section and a supply amount of the inert gas supplied by the second supply section. Additionally, in the above-described gasification unit, the gasifier has a starting burner that burns starting fuel using the oxygen-containing gas supplied from the first supply section, and the control section controls the supply amount of the inert gas supplied by the second supply section prior to starting combustion of the starting fuel by the starting burner so that an oxygen concentration of mixed gas in which combustion gas generated by combustion of the oxygen-containing gas and the starting fuel by the starting burner has been mixed with the inert gas becomes not more than an ignition concentration.

The gasification unit according to one aspect of the present invention burns the oxygen-containing gas and the starting fuel using the starting burner in order to start the gasification unit. The combustion gas generated by combustion of the oxygen-containing gas and the starting fuel is then supplied to the char recovery unit. By configuring the gasification unit as described above, after the char contained in the oxygen-containing gas and the combustion gas is recovered by the char recovery unit, the gas from which the char has been recovered is supplied to the flare equipment. Hereby, the oxygen-containing gas and the combustion gas containing the char can be prevented or suppressed from being supplied to the flare equipment.

Here, since the char containing unburned solid carbonaceous fuel is present in the char recovery unit, the unburned solid carbonaceous fuel contained in the char may be ignited in a case where an oxygen concentration of the combustion gas supplied to the char recovery unit is high.

Consequently, in the gasification unit according to one aspect of the present invention, the supply amount of the inert gas supplied to the upstream side of the char recovery unit is controlled prior to starting combustion of the starting fuel by the starting burner, and the oxygen concentration of the mixed gas in which the combustion gas generated by combustion of the oxygen-containing gas and the starting fuel has been mixed with the inert gas is set to be not more than the ignition concentration.

Hereby, the above-described gasification unit has an effect that the inert gas and the combustion gas are reliably mixed from the time of generation of the combustion gas, and that the oxygen concentration of the mixed gas in which the inert gas and the combustion gas have been mixed is reliably decreased.

By configuring the gasification unit as described above, even in a case where the oxygen concentration of the combustion gas generated by combustion of the oxygen-containing gas and the starting fuel is high, the inert gas is mixed with the combustion gas on the upstream side of the char recovery unit, and the mixed gas having the oxygen concentration not more than the ignition concentration is supplied to the char recovery unit. Therefore, ignition of the unburned solid carbonaceous fuel contained in the char present in the char recovery unit can be suppressed.

The gasification unit according to one aspect of the present invention may be configured such that the ignition concentration is lower than a lower-limit value of an oxygen concentration at which the unburned solid carbonaceous fuel contained in the char present in the char recovery unit can be ignited.

By configuring the gasification unit as described above, ignition of the unburned solid carbonaceous fuel contained in the char present in the char recovery unit can be reliably prevented.

In the above-described configuration, the ignition concentration is preferably 14 volume percent concentration.

The present inventors have obtained knowledge that in a case where a concentration of coal dust contained in the combustion gas is comparatively low, and where a pressure in the gasifier at the time of start is relatively low with respect to a steady operation pressure (for example, the pressure in the gasifier at the time of start is approximately 2 to 10 ata, while the steady operation pressure is approximately 15 to 50 ata), ignition of the unburned solid carbonaceous fuel present in the char recovery unit can be prevented by setting the oxygen concentration of the mixed gas to be not more than 14 volume percent concentration. Accordingly, ignition of the unburned solid carbonaceous fuel can be prevented by setting the oxygen concentration of the mixed gas to be not more than 14 volume percent concentration.

In the above-described configuration, the ignition concentration is preferably 12 volume percent concentration.

The present inventors have obtained knowledge that in a case where the pressure in the gasifier at the time of start is comparatively low with respect to the steady operation pressure, ignition of the unburned solid carbonaceous fuel can be reliably prevented by setting the oxygen concentration of the mixed gas to be not more than 12 volume percent concentration regardless of the concentration of the coal dust contained in the combustion gas. Accordingly, ignition of the unburned solid carbonaceous fuel can be reliably prevented by setting the oxygen concentration of the mixed gas to be not more than 12 volume percent concentration.

The gasification unit according to one aspect of the present invention may be configured such that the gasifier has a combustor burner that burns the solid carbonaceous fuel, and such that the second supply section supplies the inert gas to the combustor burner.

By configuring the gasification unit as described above, the inert gas can be mixed with the combustion gas generated by combustion of the oxygen-containing gas and the starting fuel, using the combustor burner used to burn the solid carbonaceous fuel at the time of operation of the gasification unit.

In the above-described configuration, it is preferable that the gasifier has the plurality of combustor burners, and that blow-off ports of the plurality of combustor burners are arranged toward different directions, respectively so that the gas discharged from the blow-off ports forms a center of a vortex substantially in a direction perpendicular to a gasifier cross section.

By configuring the gasification unit as described above, the vortex is formed by the inert gas discharged from the combustor burners to the gasifier, and mixing of the combustion gas generated by combustion of the oxygen-containing gas and the starting fuel with the inert gas is promoted. Accordingly, a portion with a high oxygen concentration is not present in the mixed gas, and ignition of the unburned solid carbonaceous fuel can be suppressed.

The gasification unit according to one aspect of the present invention may be configured such that the gasifier has a heat exchanger that generates steam by heat exchange of the combustible gas and water, and such that the second supply section supplies the inert gas to a downstream side of the heat exchanger, and to an upstream side of a combustible gas supply flow passage through which the combustible gas is supplied from the gasifier to the char recovery unit.

By configuring the gasification unit as described above, heat recovery efficiency of the heat exchanger can be more improved compared with a case where the inert gas is supplied to the upstream side of the heat exchanger to thereby decrease a temperature of the combustion gas.

In the gasification unit according to one aspect of the present invention, the second supply section may supply the inert gas to the combustible gas supply flow passage through which the combustible gas is supplied from the gasifier to the char recovery unit.

By configuring the gasification unit as described above, the inert gas can be supplied to the upstream side of the char recovery unit without having any effect on the gasifier, and the inert gas can be mixed with the combustion gas generated by combustion of the oxygen-containing gas and the starting fuel.

An integrated gasification combined cycle facility according to one aspect of the present invention includes: the gasification unit of the above-described aspect; gas turbine equipment that is operated using as fuel the combustible gas generated by the gasification unit; an exhaust heat recovery boiler that recovers heat in combustion exhaust gas generated by combustion of the combustible gas by the gas turbine equipment to thereby generate steam; steam turbine equipment that is operated by the steam supplied from the exhaust heat recovery boiler; and a generator that is driven by power supplied by the gas turbine equipment and power supplied by the steam turbine equipment.

By configuring the integrated gasification combined cycle facility as described above, there can be provided the integrated gasification combined cycle facility in which ignition of the unburned solid carbonaceous fuel contained in the char present in the char recovery unit has been suppressed while the gas containing the char is suppressed from being supplied to the flare equipment when the gasification unit is started.

A method for starting gasification unit according to one aspect of the present invention is the one for staring the gasification unit including: a gasifier in which combustible gas is generated by gasifying solid carbonaceous fuel using oxygen-containing gas; a char recovery unit that recovers char contained in the combustible gas generated by the gasifier; flare equipment that burns the combustible gas from which the char has been recovered by the char recovery unit; a first supply section that supplies the oxygen-containing gas to the gasifier; a second supply section that supplies inert gas to an upstream side of the char recovery unit. Additionally, the above-described method includes: a control step of controlling a supply amount of the inert gas supplied by the second supply section; and a starting combustion step of burning the oxygen-containing gas and starting fuel by a starting burner to thereby generate combustion gas. Further, in the above-described method, the control step controls the supply amount of the inert gas supplied by the second supply section prior to the starting combustion step so that an oxygen concentration of mixed gas in which the combustion gas generated by the starting combustion step has been mixed with the inert gas becomes not more than an ignition concentration.

In the method for starting the gasification unit according to one aspect of the present invention, the oxygen-containing gas and the starting fuel are burned using the starting burner by the starting combustion step in order to start the gasification unit. The combustion gas generated by combustion of the oxygen-containing gas and the starting fuel is then supplied to the char recovery unit. By configuring the integrated gasification combined cycle facility as described above, after the char contained in the oxygen-containing gas and the combustion gas is recovered by the char recovery unit, the oxygen-containing gas and the combustion gas are supplied to the flare equipment. Therefore, gas containing the char is suppressed from being supplied to the flare equipment.

Here, since the char containing unburned solid carbonaceous fuel is present in the char recovery unit, the unburned solid carbonaceous fuel contained in the char may be ignited in a case where oxygen concentrations of the oxygen-containing gas and the combustion gas supplied to the char recovery unit are high.

Consequently, in the method for starting the gasification unit according to one aspect of the present invention, the supply amount of the inert gas supplied to the upstream side of the char recovery unit is controlled prior to starting combustion of the oxygen-containing gas and the starting fuel by the starting burner, and the oxygen concentration of the mixed gas in which the combustion gas generated by combustion of the oxygen-containing gas and the starting fuel has been mixed with the inert gas is set to be not more than the ignition concentration.

By configuring the integrated gasification combined cycle facility as described above, even in a case where the oxygen concentration of the combustion gas generated by combustion of the oxygen-containing gas and the starting fuel is high, the inert gas is mixed with the combustion gas on the upstream side of the char recovery unit, and the mixed gas having the oxygen concentration not more than the ignition concentration is supplied to the char recovery unit. Therefore, ignition of the unburned solid carbonaceous fuel contained in the char present in the char recovery unit can be suppressed.

The method for starting the gasification unit according to one aspect of the present invention may be configured such that the ignition concentration is lower than a lower-limit value of an oxygen concentration at which the unburned solid carbonaceous fuel contained in the char present in the char recovery unit can be ignited.

By configuring the integrated gasification combined cycle facility as described above, therefore, ignition of the unburned solid carbonaceous fuel contained in the char present in the char recovery unit can be reliably prevented.

In the above-described configuration, the ignition concentration is preferably 14 volume percent concentration.

The present inventors have obtained knowledge that in a case where a concentration of coal dust contained in the combustion gas is comparatively low, and where a pressure in the gasifier at the time of start is comparatively low with respect to a steady operation pressure, ignition of the unburned solid carbonaceous fuel present in the char recovery unit can be prevented by setting the oxygen concentration of the mixed gas to be not more than 14 volume percent concentration. Accordingly, ignition of the unburned solid carbonaceous fuel can be prevented by setting the oxygen concentration of the mixed gas to be not more than 14 volume percent concentration.

In the above-described configuration, the ignition concentration is preferably 12 volume percent concentration.

The present inventors have obtained knowledge that in a case where the pressure in the gasifier at the time of start is comparatively low with respect to the steady operation pressure, ignition of the unburned solid carbonaceous fuel can be reliably prevented by setting the oxygen concentration of the mixed gas to be not more than 12 volume percent concentration regardless of the concentration of the coal dust contained in the combustion gas. Accordingly, ignition of the unburned solid carbonaceous fuel can be reliably prevented by setting the oxygen concentration of the mixed gas to be not more than 12 volume percent concentration.

### Advantageous Effects of Invention

According to the present invention, there can be provided the gasification unit in which ignition of the unburned solid carbonaceous fuel contained in the char present in the char recovery unit has been suppressed while the gas containing the char is suppressed from being supplied to the flare equipment when the gasification unit is started, the integrated gasification combined cycle facility including the gasification unit, and the method for starting the gasification unit.

### BRIEF DESCRIPTION OF DRAWINGS

FIG. 1 is a system diagram showing an integrated gasification combined cycle facility of a first embodiment.

FIG. 2 is a longitudinal cross-sectional view showing a coal gasifier of the first embodiment.

FIG. 3 is a transverse cross-sectional view of the coal gasifier showing directions of blow-off ports of combustor burners.

FIG. 4 is a flow chart showing a starting step of the integrated gasification combined cycle facility of the first embodiment.

FIG. 5 is a flow chart showing a Comparative Example of the starting step of the integrated gasification combined cycle facility.

FIGS. 6(a) and 6(b) are graphs each showing a flow rate of gas discharged from a char recovery unit, FIG. 6(a) shows the flow rate of the gas in the starting step of the first embodiment, and FIG. 6(b) shows the flow rate of the gas in the Comparative Example of the starting step.

FIGS. 7(a) and 7(b) are graphs each showing an oxygen concentration of mixed gas discharged from the coal gasifier, FIG. 7(a) shows the oxygen concentration of the mixed gas in the starting step of the first embodiment, and FIG. 7(b) shows the oxygen concentration of the mixed gas in the Comparative Example of the starting step.

FIG. 8 is a graph showing a relation between a coal dust concentration of pulverized coal and an oxygen concentration in a boundary of an ignition region and a non-ignition region.

FIG. 9 is a longitudinal cross-sectional view showing a coal gasifier of a second embodiment.

FIG. 10 is a longitudinal cross-sectional view showing a coal gasifier of a third embodiment.

FIG. 11 is a longitudinal cross-sectional view showing a coal gasifier of a fourth embodiment.

### DESCRIPTION OF EMBODIMENTS

### First Embodiment

Hereinafter, an integrated gasification combined cycle facility of a first embodiment of the present invention will be explained using drawings.

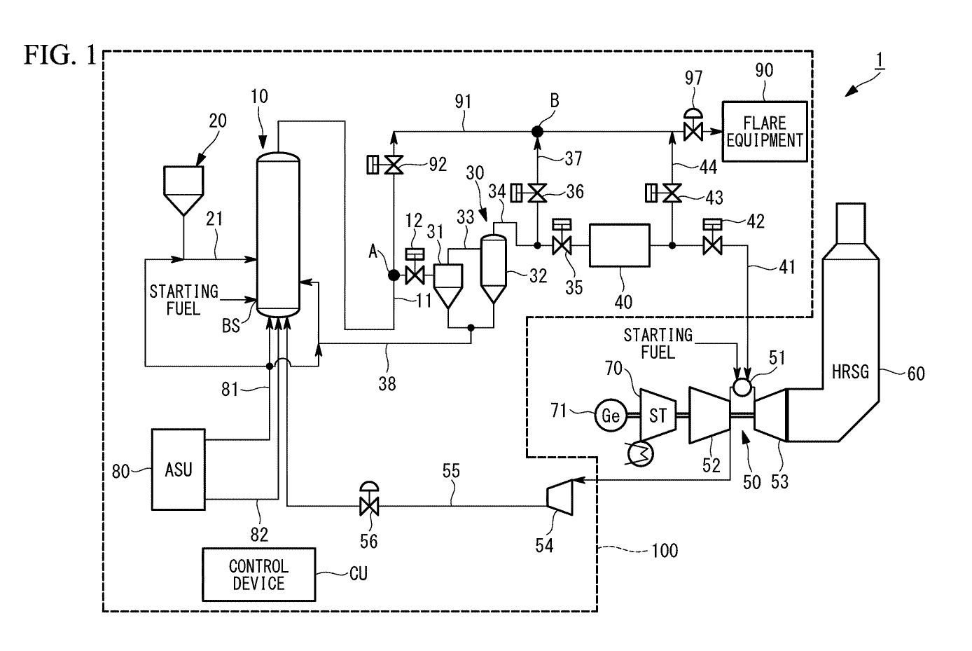

As shown in FIG. 1, an integrated gasification combined cycle (IGCC) facility 1 of the embodiment includes: coal gasification unit 100; gas turbine equipment 50; an exhaust heat recovery boiler 60; steam turbine equipment 70; and a generator 71.

The coal gasification unit 100 is the equipment for gasifying coal, which is solid carbonaceous fuel, to thereby generate combustible gas. The combustible gas generated by the coal gasification unit 100 is supplied to a combustor 51 of the gas turbine equipment 50 through a combustible gas supply flow passage 41. Details of the coal gasification unit 100 will be mentioned later.

The gas turbine equipment 50 includes: the combustor 51; a compressor 52; and a gas turbine 53. The combustor 51 burns the combustible gas supplied from the coal gasification unit 100 using a compressed air compressed by the compressor 52. When the combustible gas is burned as described above, high-temperature and high-pressure combustion gas is generated to be supplied from the combustor 51 to the gas turbine 53. As a result of this, the high-temperature and high-pressure combustion gas works to drive the gas turbine 53, and high-temperature combustion exhaust gas is discharged. Additionally, a rotation-shaft output of the gas turbine 53 is used as drive sources of the generator 71 and the compressor 52, which will be mentioned later.

The compressor 52 supplies a part of the compressed air to the combustor 51 in order to burn the combustible gas, and the other part of the compressed air is supplied to an extracted air booster 54 of the coal gasification unit 100. The compressed air supplied to the extracted air booster 54 is supplied to a coal gasifier 10 in a state of being boosted.

The exhaust heat recovery boiler 60 is equipment that recovers heat held by the high-temperature combustion exhaust gas discharged from the gas turbine 53, and that generates steam. The exhaust heat recovery boiler 60 generates the steam by heat exchange of the combustion exhaust gas and water, and supplies the generated steam to the steam turbine equipment 70. The exhaust heat recovery boiler 60 emits to the atmosphere the combustion exhaust gas whose temperature has been decreased by the heat exchange with water, after necessary treatment is performed to the combustion exhaust gas.

The steam turbine equipment 70 is the equipment that rotates a rotation shaft to which the generator 71 is coupled, with the steam supplied from the exhaust heat recovery boiler 60 being used as a drive source.

The generator 71 is coupled to the rotation shaft driven by both the gas turbine equipment 50 and the steam turbine equipment 70, and generates electric power by rotation of the rotation shaft.

As explained above, the integrated gasification combined cycle facility 1 of the embodiment drives the gas turbine equipment 50 by the combustible gas generated by gasifying coal, generates steam by the combustion exhaust gas discharged from the gas turbine equipment 50, drives the steam turbine equipment 70 by the generated steam, and generates electric power by the generator 71 with the gas turbine equipment 50 and the steam turbine equipment 70 being used as the drive sources.

Next, the coal gasification unit 100 of the embodiment will be explained in more detail.

As shown in FIG. 1, the coal gasification unit 100 includes: the coal gasifier (a gasifier) 10; a coal supply device 20; a char recovery unit 30; gas purification equipment 40; an air separation unit (ASU) 80; flare equipment 90; the extracted air booster 54; and a control unit CU.

The coal gasifier 10 is a device that gasifies pulverized coal supplied together with a gasifying agent to thereby generate combustible gas. For example, a furnace of a system called an air-blown two-stage entrained flow gasifier is employed for the coal gasifier 10. The coal gasifier 10 is the device that partially burns the pulverized coal (solid carbonaceous fuel) introduced together with the gasifying agent to thereby gasify it. Additionally, the combustible gas generated in the coal gasifier 10 is guided to the char recovery unit 30, which will be mentioned later, through a combustible gas supply flow passage 11.

Air, an oxygen-enriched air, oxygen, steam, etc. can be exemplified as the gasifying agent supplied to the coal gasifier 10. The gasifying agent is, for example, used as follows. Oxygen supplied from the air separation unit (ASU) 80 is mixed with the compressed air introduced from the gas turbine equipment 50 through the extracted air booster 54. Details of the coal gasifier 10 will be mentioned later.

The coal supply device 20 is the device that pulverizes coal, which is solid carbonaceous fuel, using a coal mill (illustration is omitted) to thereby generate pulverized coal, and that supplies it to the coal gasifier 10. The pulverized coal generated by the coal supply device 20 is supplied to the coal gasifier 10 by being conveyed by nitrogen gas (inert gas) supplied from the air separation unit 80 through an inert gas supply flow passage 81.

For example, the inert gas is inactive gas having an oxygen content not more than approximately 5 volume %, and nitrogen gas, carbon dioxide gas, argon gas, etc. are representative examples, but the inert gas is not necessarily limited to the one having the oxygen content not more than approximately 5%.

The char recovery unit 30 is the device that separates and recovers char (unburned pulverized coal) contained in the combustible gas supplied from the coal gasifier 10 from the combustible gas. The char recovery unit 30 has a configuration in which a cyclone 31 and a porous filter 32 have been connected in series through a coupling pipe 33. The combustible gas from which the char has been separated and removed by the char recovery unit 30 is guided to the gas purification equipment 40 through a combustible gas supply flow passage 34.

The cyclone 31 separates and removes the char contained in the combustible gas supplied from the coal gasifier 10, and supplies a combustible gas component to the porous filter 32.

The porous filter 32 is the filter installed on a downstream side of the cyclone 31, and recovers fine char contained in the combustible gas.

The char recovered by the char recovery unit 30 is supplied to the coal gasifier 10 through a char recovery flow passage 38 by being conveyed by the nitrogen gas (the inert gas) supplied through the inert gas supply flow passage 81.

The gas purification equipment 40 is the equipment that purifies the combustible gas from which the char has been separated and removed by the char recovery unit 30 to thereby remove impurities, and that purifies gas having a property suitable for fuel gas of the gas turbine equipment 50. The combustible gas purified by the gas purification equipment 40 is supplied to the combustor 51 of the gas turbine equipment 50 through the combustible gas supply flow passage 41.

The air separation unit 80 is a device that liquefies air by cooling it while compressing it, and that separates the liquefied air into oxygen gas, nitrogen gas, argon gas, and the others by distillation. The oxygen gas separated by the air separation unit 80 is supplied to the coal gasifier 10 through an oxygen supply flow passage 82 (a first supply section). A part of the nitrogen gas separated by the air separation unit 80 is supplied to the coal gasifier 10 through the inert gas supply flow passage 81. The other part of the nitrogen gas separated by the air separation unit 80 is supplied to a pulverized fuel supply flow passage 21 and the char recovery flow passage 38 as conveying gas through the inert gas supply flow passage 81.

The air separation unit 80 can adjust a flow rate of the nitrogen gas supplied to the inert gas supply flow passage 81, and a flow rate of the oxygen gas supplied to the oxygen supply flow passage 82 according to a control signal transmitted from the control unit CU, which will be mentioned later, respectively.

The flare equipment 90 is the equipment that burns the combustible gas from which the char has been recovered by the char recovery unit 30. The flare equipment 90 burns the gas discharged from the coal gasifier 10, and emits it to the atmosphere, at the time of start or stop of the integrated gasification combined cycle facility 1. The flare equipment 90 burns unburned fuel contained in combustion gas generated by burning starting fuel by a starting burner of the coal gasifier 10 at the time of start of the integrated gasification combined cycle facility 1.

In addition, the flare equipment 90 burns the combustible gas purified by the gas purification equipment 40 at the time of stop of the integrated gasification combined cycle facility 1. In addition, the flare equipment 90 can also burn excess combustible gas generated during operation of the integrated gasification combined cycle facility 1.

The extracted air booster 54 is a device that boosts the compressed air extracted from the compressor 52 of the gas turbine equipment 50, and that supplies it to the coal gasifier 10. The compressed air boosted by the extracted air booster 54 is supplied to the coal gasifier 10 through an air supply flow passage 55.

The control unit (a control section) CU is a device that controls each section of the coal gasification unit 100. The control unit CU executes various control operations explained below by reading and executing a control program from a storage section (illustration is omitted) in which the control program for executing the control operations has been stored.

The control unit CU outputs to the air separation unit 80 a control signal to control the flow rate of the nitrogen gas supplied to the inert gas supply flow passage 81 by the air separation unit 80, and thereby controls the flow rate of the nitrogen gas supplied from the air separation unit 80 to the coal gasifier 10, the pulverized fuel supply flow passage 21, and the char recovery flow passage 38.

In addition, the control unit CU outputs to the air separation unit 80 a control signal to control the flow rate of the oxygen gas supplied to the oxygen supply flow passage 82 by the air separation unit 80, and thereby controls the flow rate of the oxygen gas supplied from the air separation unit 80 to the coal gasifier 10.

In addition, the control unit CU outputs a control signal to adjust an opening of an air flow rate adjustment valve (a first supply section) 56 to the air flow rate adjustment valve 56, and thereby controls a flow rate of the compressed air supplied from the extracted air booster 54 to the coal gasifier 10.

As described above, the oxygen supply flow passage 82 of the air separation unit 80 and the air flow rate adjustment valve 56 function as the first supply section that supplies to the coal gasifier 10 the oxygen gas and the compressed air, which are oxygen-containing gas, respectively.

In addition, the inert gas supply flow passage 81 of the air separation unit 80 functions as a second supply section that supplies the nitrogen gas, which is the inert gas, to an upstream side of the char recovery unit 30.

In addition, the control unit CU can adjust a pressure inside the coal gasifier 10 by outputting to a pressure adjustment valve 97 a control signal to adjust an opening of the pressure adjustment valve 97.

Here, there will be explained an opening and closing valve provided in and on the flow passage through which the combustible gas discharged from the coal gasifier 10 flows.

The combustible gas discharged from the coal gasifier 10 branches at an downstream end A of the combustible gas supply flow passage 11, and flows into the char recovery unit 30 or a bypass main flow passage 91.

The bypass main flow passage 91 is the flow passage from the upstream end A to a downstream end B, and is the flow passage for supplying the combustible gas discharged from the coal gasifier 10 to the flare equipment 90 without the combustible gas being passed through the char recovery unit 30. An opening and closing valve 92 provided in the bypass main flow passage 91 becomes an opened state in a case where the integrated gasification combined cycle facility 1 is stopped in an emergency.

In a case where the opening and closing valve 92 provided in the bypass main flow passage 91 is in the closed state, and where an opening and closing valve 12 provided on the upstream side of the char recovery unit 30 is in a opened state, the combustible gas discharged from the coal gasifier 10 is supplied to the char recovery unit 30.

The combustible gas supplied to the char recovery unit 30 is supplied to the porous filter 32 via the coupling pipe 33 from the cyclone 31. The combustible gas from which fine char has been removed by the porous filter 32 is supplied to the combustible gas supply flow passage 34.

A branch piping 37 branches on an upstream side of an opening and closing valve 35 from the combustible gas supply flow passage 34, and is connected to the bypass main flow passage 91. An opening and closing valve 36 is provided in the branch piping 37.

In addition, a branch piping 44 branches on an upstream side of an opening and closing valve 42 provided in the combustible gas supply flow passage 41 that connects the gas purification equipment 40 and the combustor 51, and is connected to the bypass main flow passage 91. An opening and closing valve 43 is provided in the branch piping 44.

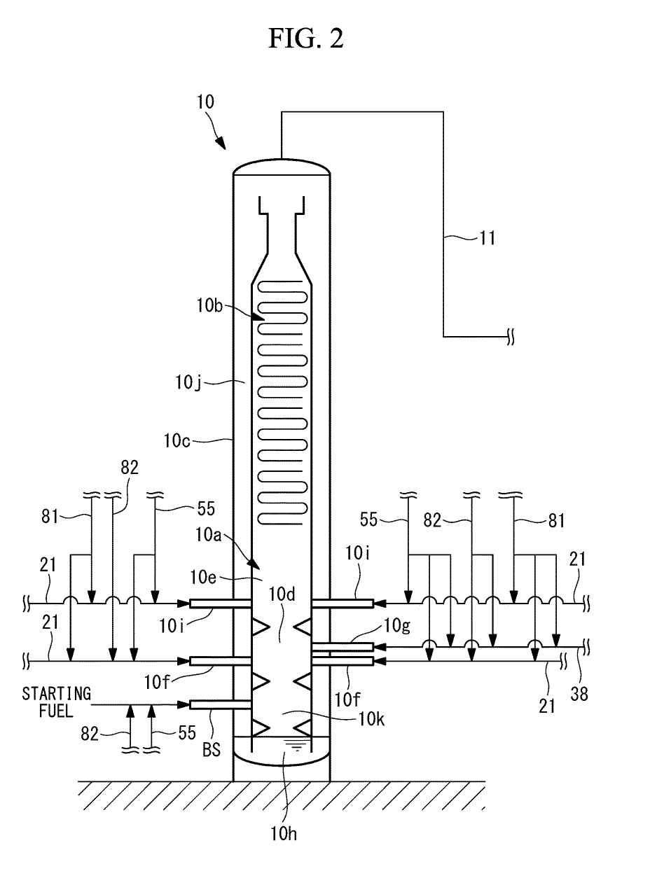

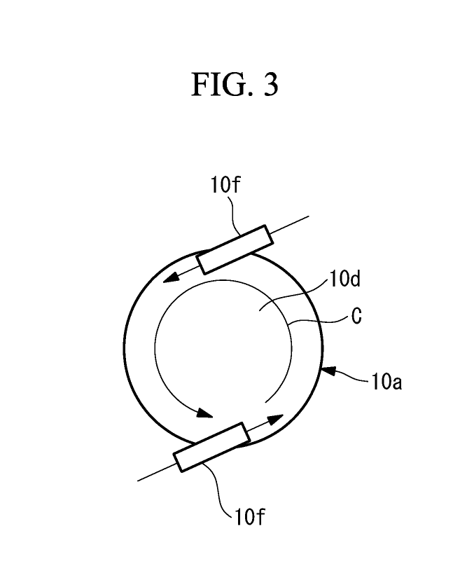

Next, the coal gasifier 10 of the embodiment will be explained in more detail using FIGS. 2 and 3.

The coal gasifier 10 includes: a gasification section 10a; a syngas cooler (a heat exchanger) 10b; and a pressure container 10c as shown in FIG. 2.

In the gasification section 10a, a combustor 10d and a reductor 10e are arranged in that order from a lower side. The gasification section 10a includes the combustor 10d and the reductor 10e. The gasification section 10a is formed so that gas may flow from the lower side to an upper side. In addition, in the coal gasifier 10, the syngas cooler 10b is provided at an upper part of the reductor 10e of the gasification section 10a.

Pulverized coal, air, and oxygen gas are put in the combustor 10d from the combustor burner 10f, and char recovered by the char recovery unit 30 is put in the combustor 10d from a char burner 10g. The combustor 10d then burns a part of the pulverized coal and the char, and is maintained to be a high-temperature state necessary for a gasification reaction in the reductor 10e. The remainder of the pulverized coal and the char is thermally decomposed to volatile matters (carbon monoxide, hydrogen, lower hydrocarbon, etc.). In addition, in the combustor 10d, ashes of the melted pulverized coal are stored in an ash hopper 10h, and are discharged from the lower side of the gasification section 10a. The melted ashes are rapidly cooled by water and pulverized to be glassy slag.

In the reductor 10e, the pulverized coal put in from a reductor burner 10i is gasified by high-temperature gas supplied from the combustor 10d. Hereby, gas, such as carbon monoxide and hydrogen, is generated from the pulverized coal. A coal gasification reaction is an endothermic reaction in which carbon in pulverized coal and char reacts with carbon dioxide and moisture in high-temperature gas to thereby generate carbon monoxide and hydrogen.

The pulverized coal from the coal supply device 20 is supplied to the combustor burner 10f through the pulverized fuel supply flow passage 21 together with the nitrogen gas separated in the air separation unit 80. The compressed air is supplied from the extracted air booster 54 to the combustor burner 10f through the air supply flow passage 55. In addition, the oxygen gas is supplied from the air separation unit 80 to the combustor burner 10f through the oxygen supply flow passage 82. Further, the nitrogen gas is supplied to the combustor burner 10f through the inert gas supply flow passage 81. The compressed air and the oxygen gas are supplied to the coal gasifier 10 as gasifying agents (oxidizing agents). The pulverized coal, the air, the nitrogen gas, and the oxygen gas are then put into the combustor 10d from the combustor burner 10f.

An amount of the pulverized coal, a flow rate of the oxygen gas, a flow rate of the nitrogen gas, and a flow rate of the compressed air that are supplied to the combustor burner 10f are adjusted by flow rate adjustment valves (illustration are omitted) provided in each of the pulverized fuel supply flow passage 21, the oxygen supply flow passage 82, the inert gas supply flow passage 81, and the air supply flow passage 55. Openings of the flow rate adjustment valves (illustration is omitted) are controlled by control signals output from the control unit CU to the flow rate adjustment valves.

As shown in FIG. 3, the coal gasifier 10 has the plurality of combustor burners 10f. In addition, blow-off ports of the plurality of combustor burners 10f are arranged toward different directions, respectively so that gas (the mixed gas of the pulverized coal, the oxygen gas, the nitrogen gas, and the compressed air) discharged from the blow-off ports may form a vortex C.

The char from the char recovery unit 30 is supplied to the char burner 10g through the char recovery flow passage 38 together with the nitrogen gas separated in the air separation unit 80. The compressed air is supplied from the extracted air booster 54 to the char burner 10g through the air supply flow passage 55. In addition, the oxygen gas is supplied from the air separation unit 80 to the char burner 10g through the oxygen supply flow passage 82. Further, the nitrogen gas is supplied to the char burner 10g through the inert gas supply flow passage 81. The compressed air and the oxygen gas are supplied to the coal gasifier 10 as gasifying agents (oxidizing agents). The char, the air, the nitrogen gas, and the oxygen gas are then put into the combustor 10d from the char burner 10g.

An amount of the pulverized coal, a flow rate of the oxygen gas, a flow rate of the nitrogen gas, and a flow rate of the compressed air that are supplied to the char burner 10g are adjusted by flow rate adjustment valves (illustration are omitted) provided in each of the char recovery flow passage 38, the oxygen supply flow passage 82, the inert gas supply flow passage 81, and the air supply flow passage 55. Openings of the flow rate adjustment valves (illustration is omitted) are controlled by control signals output from the control unit CU to the flow rate adjustment valves.

The pulverized coal from the coal supply device 20 is supplied to the reductor burner 10i through the pulverized fuel supply flow passage 21 together with nitrogen gas separated in the air separation unit 80. The compressed air is supplied from the extracted air booster 54 to the reductor burner 10i through the air supply flow passage 55. In addition, the nitrogen gas is supplied to the reductor burner 10i through the inert gas supply flow passage 81. The pulverized coal is then put into the reductor 10e from the reductor burner 10i.

An amount of the pulverized coal, a flow rate of the nitrogen gas, and a flow rate of the compressed air that are supplied to the reductor burner 10i are adjusted by flow rate adjustment valves (illustration are omitted) provided in each of the pulverized fuel supply flow passage 21, the inert gas supply flow passage 81, and the air supply flow passage 55. Openings of the flow rate adjustment valves (illustration is omitted) are controlled by control signals output from the control unit CU to the flow rate adjustment valves.

The syngas cooler 10b is provided on a downstream side of the gasification section 10a, i.e. at an upper part of the gasification section 10a. The syngas cooler 10b may include the plurality of heat exchangers. In the syngas cooler 10b, sensible heat is obtained from high-temperature gas guided from the reductor 10e, and water guided to the syngas cooler 10b is generated as steam. Generated gas that has passed through the syngas cooler 10b is cooled, and is subsequently discharged to the combustible gas supply flow passage 11.

The pressure container 10c is the container that can withstand a pressure from an inside, and houses the gasification section 10a and the syngas cooler 10b thereinside. The pressure container 10c, the gasification section 10a, and the syngas cooler 10b are arranged in common in an axis.

An annulus section 10j is provided between an inner wall portion of the pressure container 10c and an outer wall portion of the gasification section 10a or the syngas cooler 10b.

A starting combustion chamber 10k is further provided at the lower side of the gasification section 10a, and burns the starting fuel supplied from a starting burner BS. The oxygen gas and the compressed air, which are oxygen-containing gas, are supplied to the starting burner BS from the oxygen supply flow passage 82 and the air supply flow passage 55. The starting burner BS burns the oxygen-containing gas and the starting fuel. An amount of oxygen gas supplied from the oxygen supply flow passage 82 to the starting burner BS, and an amount of air supplied from the air supply flow passage 55 to the starting burner BS are adjusted by flow rate adjustment valves (illustration are omitted), respectively.

For example, kerosene, light oil, natural gas, etc. are used as the starting fuel.

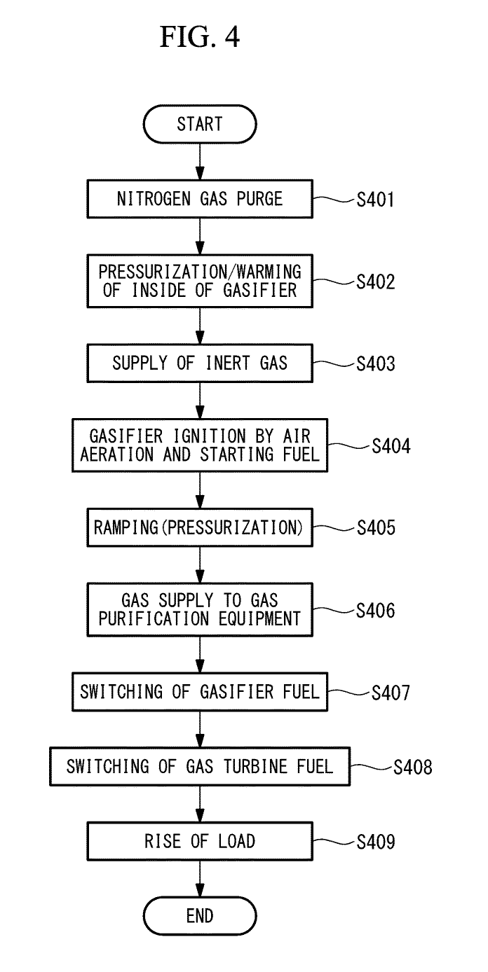

Next, starting steps of the integrated gasification combined cycle facility 1 of the embodiment will be explained using a flow chart shown in FIG. 4.

Each process of the flow chart shown in FIG. 4 shall be executed by the control unit CU controlling each section of the integrated gasification combined cycle facility 1. However, at least a part of the respective processes, such as opening and closing operations of the opening and closing valves 12, 35, 36, 42, 43, and 92 may be executed by workers of the integrated gasification combined cycle facility 1.

In step S401, the control unit CU outputs a control signal to the air separation unit 80, and controls the air separation unit 80 so that the nitrogen gas is supplied to the coal gasifier 10 through the inert gas supply flow passage 81. Supply of the nitrogen gas to the coal gasifier 10 through the inert gas supply flow passage 81 is continued until each process shown in FIG. 4 is ended.

In step S401, the control unit CU sets the opening and closing valves 35, 42, and 92 to be closed state, and sets the opening and closing valves 12, 36, and 43 to be opened state.

As described above, in step S401, the nitrogen gas supplied to the coal gasifier 10 is guided to the flare equipment 90 via the branch piping 37 and the bypass main flow passage 91 from the char recovery unit 30.

In a manner as described above, the coal gasifier 10, the char recovery unit 30, and the flare equipment 90 are purged by the nitrogen gas.

In step S402, the control unit CU outputs a control signal to reduce the opening of the pressure adjustment valve 97, blocks the flow passage from the coal gasifier 10 to the flare equipment 90, and pressurizes the inside of the coal gasifier 10 by the nitrogen gas. In addition, the control unit CU warms the coal gasification unit 100 by supplying the nitrogen gas and water to each section included in the coal gasification unit 100.

In step S403, the control unit CU outputs a control signal to a flow rate adjustment valve (illustration is omitted) provided on a flow passage that branches from the inert gas supply flow passage 81 and is connected to the pulverized fuel supply flow passage 21, and controls the flow rate adjustment valve so that the nitrogen gas may be supplied to the pulverized fuel supply flow passage 21. The nitrogen gas supplied to the pulverized fuel supply flow passage 21 flows into the combustor 10d of the coal gasifier 10 from the combustor burner 10f.

Supply of the nitrogen gas in step S403 is started prior to combustion of the starting fuel in step S404 (gasifier ignition by the starting fuel). A reason why the supply of the nitrogen gas is started prior to the combustion of the starting fuel is to reliably mix the nitrogen gas with the combustion gas generated by combustion of the starting fuel from the time of combustion start, and to reliably decrease an oxygen concentration of mixed gas of the nitrogen gas and the combustion gas without the oxygen concentration being high even temporarily.

In a case where steps S403 and S404 are simultaneously performed, combustion gas may be generated before a flow rate of the nitrogen gas that flows into the combustor 10d from the combustor burner 10f becomes a sufficient one, and the oxygen concentration of the mixed gas of the combustion gas and the nitrogen gas may be unable to sufficiently suppress ignition of unburned solid carbonaceous fuel. The oxygen concentration of the mixed gas is reliably decreased, and thereby ignition of the unburned solid carbonaceous fuel contained in the char in the char recovery unit 30 can be suppressed.

How long prior to the time of starting combustion of the starting fuel supply of the nitrogen gas in step S403 should be started shall be defined by various conditions, such as performance of the air separation unit 80 and specifications of the coal gasifier 10. Specifically, in consideration of the above-mentioned conditions, the timing of starting supply of the nitrogen gas in step S403 is defined so that the coal gasifier 10 may become a state where a targeted flow rate of nitrogen gas flows into the combustor 10d from the combustor burner 10f at the time of starting combustion of the starting fuel in step S404.

The timing is before generation start of the combustion gas at least including the time of gasifier ignition by the starting fuel, and it is set to be several seconds to several minutes before the gasifier is ignited.

In step S403, the control unit CU adjusts the flow rate of the nitrogen gas supplied to the inert gas supply flow passage 81 by the air separation unit 80 so that the oxygen concentration of the mixed gas in which the combustion gas generated by combustion of the air (oxygen-containing gas) aerated in step S404 that will be mentioned later and the starting fuel has been mixed with the nitrogen gas may become not more than an ignition concentration.

Here, the ignition concentration is, for example, desirably set to be lower than a lower-limit value of an oxygen concentration at which the unburned solid carbonaceous fuel contained in the char present in the char recovery unit can be ignited. Although the lower-limit value of the oxygen concentration is changed depending on coal composition, an installation environment of the integrated gasification combined cycle facility 1, etc., for example, 14 volume percent concentration, or more preferably 12 volume percent concentration is exemplified.

Here, the lower-limit value of the oxygen concentration will be explained.

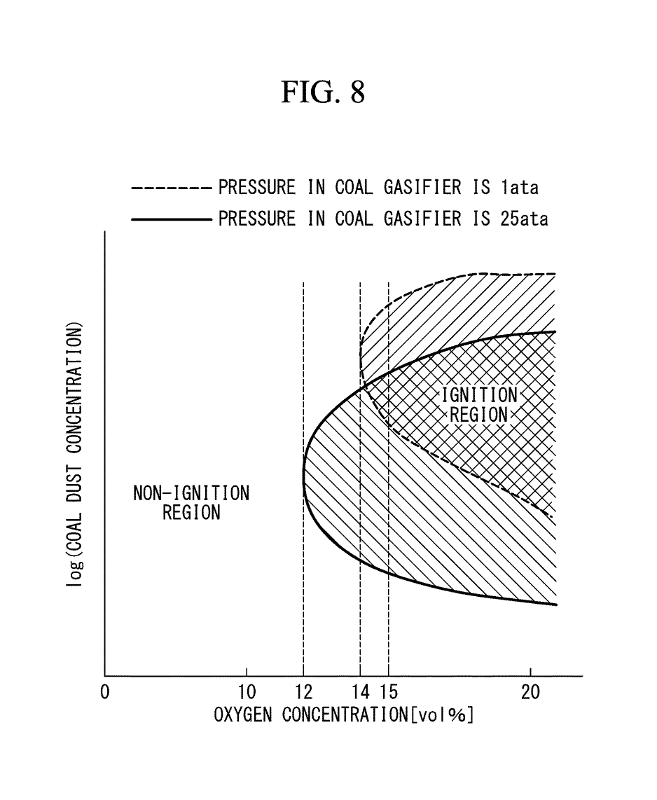

FIG. 8 is a graph showing a relation between a coal dust concentration of pulverized coal and an oxygen concentration in a boundary of an ignition region and a non-ignition region. A vertical axis shows the coal dust concentration, and a horizontal axis shows the oxygen concentration. The vertical axis is represented by a logarithmic axis. An example shown in FIG. 8 is based on experimental data obtained by the present inventors in order to set the lower-limit value of the oxygen concentration controlled by the control unit CU of the embodiment. Consequently, the example shown in FIG. 8 does not directly show the relation between the coal dust concentration and the oxygen concentration in the coal gasifier 10 of the embodiment.

A continuous line in FIG. 8 shows the relation between the coal dust concentration of the pulverized coal and the oxygen concentration in the boundary of the ignition region and the non-ignition region in a case where an absolute pressure of an atmosphere in which pulverized coal is present is 25 ata. Meanwhile, a broken line in FIG. 8 shows the relation between the coal dust concentration of the pulverized coal and the oxygen concentration in the boundary of the ignition region and the non-ignition region in a case where the absolute pressure of the atmosphere in which pulverized coal is present is an atmospheric pressure (1 ata).

In both the continuous line and the broken line, a left side of the line (a side where the oxygen concentration is lower) is the non-ignition region, and a right side of the line (a side where the oxygen concentration is higher) is the ignition region. Although both the continuous line and the broken line show the boundaries of the ignition region and the non-ignition region, the pulverized coal cannot be actually ignited even in the ignition region depending on the other conditions, such as humidity and temperature.

As shown in FIG. 8, in a case where the oxygen concentration of the atmosphere in which the pulverized coal is present is not more than 15 volume percent concentration, if conditions are satisfied where the concentration of the coal dust is comparatively low, and where the pressure in the coal gasifier 10 is comparatively low with respect to the steady operation pressure, unburned solid carbonaceous fuel that satisfies the conditions is present in the non-ignition region.

Since the char recovery unit 30 is pressurized to be substantially the same pressure as the coal gasifier 10 at the time of start, ignition of the unburned solid carbonaceous fuel present in the char recovery unit 30 is prevented by satisfying the above-mentioned conditions.

Accordingly, the oxygen concentration of the mixed gas is set to be not more than 15 volume percent concentration, and further the above-mentioned conditions are satisfied, whereby ignition of the unburned solid carbonaceous fuel present in the char recovery unit 30 can be prevented even if the combustion gas is supplied to the char recovery unit 30.

Particularly, in a case where the oxygen concentration of the mixed gas is not more than 14 volume percent concentration, if the pressure in the coal gasifier is not more than 1 ata, the unburned solid carbonaceous fuel is present in the non-ignition region even in any coal dust concentration. Accordingly, even if the combustion gas is supplied to the char recovery unit 30, ignition of the unburned solid carbonaceous fuel present in the char recovery unit 30 can be prevented.

In addition, as shown in FIG. 8, in a case where the oxygen concentration of the atmosphere in which the pulverized coal is present is not more than 12 volume percent concentration, if the pressure in the gasifier at the time of start satisfies a condition of being comparatively low with respect to the steady operation pressure, the pulverized coal that satisfies the condition is present in the non-ignition region. As shown in FIG. 8, in the case where the oxygen concentration is not more than 12 volume percent concentration, even though the pressure in the coal gasifier 10 is sufficiently higher, i.e. 25 ata, than the pressure in the coal gasifier 10 at the time of start, the pulverized coal is present in the non-ignition region regardless of the coal dust concentration. Therefore, in a case where the pressure in the coal gasifier 10 is sufficiently lower than 25 ata, the pulverized coal is present in the non-ignition region.

Accordingly, the oxygen concentration of the mixed gas is set to be not more than 12 volume percent concentration, and further the above-mentioned conditions are satisfied, whereby even if the combustion gas is supplied to the char recovery unit 30, ignition of the unburned solid carbonaceous fuel present in the char recovery unit 30 can be reliably prevented.

In step S404, the control unit CU increases the opening of the air flow rate adjustment valve 56 of the closed state, and starts supply of the compressed air to the coal gasifier 10 through the air supply flow passage 55, the compressed air being supplied from the extracted air booster 54. In addition, the control unit CU confirms that the flow rate of the nitrogen gas whose supply has been started in step S403 has reached a target flow rate, and it subsequently supplies the starting fuel to the starting burner BS, and starts combustion by the starting fuel. Combustion gas is generated in the starting combustion chamber 10k by the combustion.

In step S404, the opening and closing valves 35, 42, and 92 are in the closed state, and the opening and closing valves 12, 36, and 43 are in the opened state. Accordingly, the combustion gas generated in the starting combustion chamber 10k is supplied to the char recovery unit 30 together with the air to be aerated. The combustion gas and the air supplied to the char recovery unit 30 are supplied to the flare equipment 90 after the char contained in the combustion gas is removed, which is thus preferable in a point where the char is suppressed from being contained in treatment gas from the flare equipment 90.

In step S405, the control unit CU sets the opening and closing valves 12, 35, 36, and 42 to be closed state, and sets the opening and closing valves 92 and 43 to be opened state. In addition, the control unit CU outputs a control signal to increase the opening of the air flow rate adjustment valve 56, and a control signal to decrease the opening of the pressure adjustment valve 97. Hereby, the inside of the coal gasifier 10 is further pressurized by the compressed air supplied from the extracted air booster 54 to the coal gasifier 10.

In step S406, the control unit CU sets the opening and closing valves 92, 36, and 42 to be closed state, and sets the opening and closing valves 12, 35, and 43 to be opened state. Hereby, the combustion gas that has been generated in the coal gasifier 10, and from which the char has been recovered by the char recovery unit 30 is supplied to the gas purification equipment 40. The combustion gas that has gone through the gas purification equipment 40 is supplied to the flare equipment 90 via the branch piping 44.

In step S407, the control unit CU stops supply of the starting fuel to the starting burner, and starts supply of the pulverized coal from the coal supply device 20 to the combustor burner 10f. Hereby, gasifier fuel used by the coal gasifier 10 is switched from the starting fuel to the pulverized coal.

In step S408, the control unit CU sets the opening and closing valves 92, 36, and 43 to be closed state, and sets the opening and closing valves 12, 35, and 42 to be opened state. Hereby, the combustible gas generated by the coal gasifier 10 and purified in the gas purification equipment 40 is supplied to the combustor 51 of the gas turbine equipment 50. Along with the above, the control unit CU stops supply of the starting fuel in order to stop combustion in the combustor 51 using the starting fuel, the combustion having been started before step S401. Hereby, gas turbine fuel used by the gas turbine equipment 50 is switched from the starting fuel to the coal gasification combustible gas.

In step S409, the control unit CU gradually raises a load of the integrated gasification combined cycle facility 1 by increasing an output of the extracted air booster 54, a supply amount of the oxygen gas from the air separation unit 80 to the oxygen supply flow passage 82, a coal supply amount of the coal supply device 20, etc. The control unit CU determines that the starting step of the integrated gasification combined cycle facility 1 has been completed in a case where the load of the integrated gasification combined cycle facility 1 reaches a desired load.

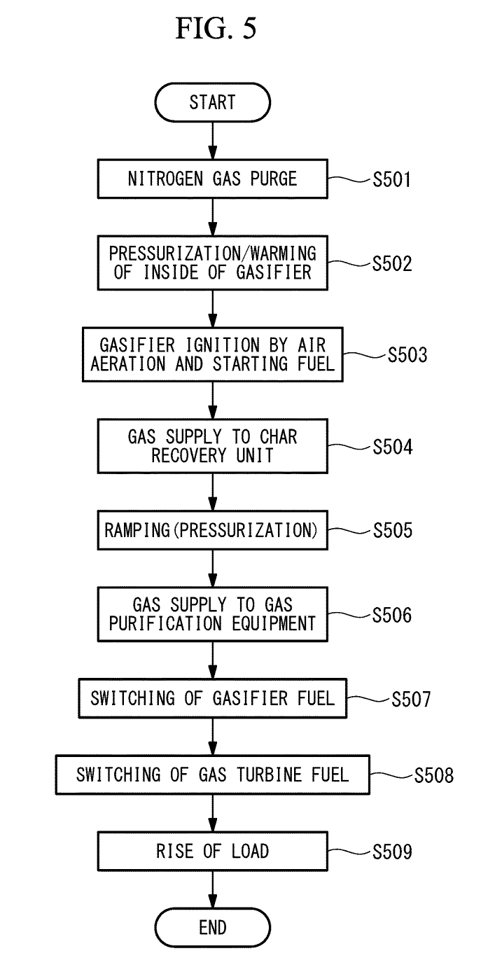

Next, a Comparative Example of the starting step of the integrated gasification combined cycle facility 1 will be explained using FIG. 5.

Note that since steps S501, S502, and S505 to S509 in FIG. 5 are similar to steps S401, S402, and S405 to S409, explanation thereof is omitted.

In step S503 in FIG. 5, the control unit CU increases the opening of the air flow rate adjustment valve 56 of the closed state, and starts supply of the compressed air to the coal gasifier 10 through the air supply flow passage 55, the compressed air being supplied from the extracted air booster 54. In addition, the control unit CU supplies the starting fuel to the starting burner BS, and starts combustion by the starting fuel. Combustion gas is generated in the starting combustion chamber 10k by the combustion.

In step S503, the control unit CU sets the opening and closing valves 12, 35, 36, and 42 to be closed state, and sets the opening and closing valves 92 and 43 to be opened state. Accordingly, the combustion gas generated in the starting combustion chamber 10k is supplied to the bypass main flow passage 91 without being supplied to the char recovery unit 30. The combustion gas supplied to the bypass main flow passage 91 is supplied to the flare equipment 90 without the char contained in the combustion gas being removed.

In step S504, the control unit CU sets the opening and closing valves 92, 35, and 42 to be closed state, and sets the opening and closing valves 12, 36, and 43 to be opened state. Accordingly, the combustion gas generated in the starting combustion chamber 10k is supplied to the char recovery unit 30. The combustion gas supplied to the char recovery unit 30 is supplied to the flare equipment 90 after the char contained in the combustion gas is removed.

As described above, in the Comparative Example of the starting step of the integrated gasification combined cycle facility 1, in step S503, the combustion gas is supplied to the flare equipment 90 without the char contained in the combustion gas being removed. Therefore, the char contained in the combustion gas may be contained in gas emitted from the flare equipment 90.

In addition, since the combustion gas generated by combustion of the starting fuel is not supplied to the char recovery unit 30 until step S503 is completed, the porous filter 32 is not warmed. Accordingly, in the Comparative Example of the starting step of the integrated gasification combined cycle facility 1, a time required for the porous filter 32 to be set to be not less than a predetermined temperature (for example, approximately 160° C. of a sulfuric acid dew point) is longer compared with the starting step of the embodiment.

A reason why the porous filter 32 is desirably set to be not less than approximately 160° C. of the sulfuric acid dew point is to suppress that a sulfur content contained in the gas supplied to the porous filter 32 is oxidized to generate SO₂, SO₂ is converted into SO₃ by oxidization, and that thereby eventually corrosion occurs due to the sulfur contents.

Meanwhile, in FIG. 4 showing the starting step of the integrated gasification combined cycle facility 1 of the embodiment, the supply amount of the nitrogen gas supplied to the inert gas supply flow passage 81 by the air separation unit 80 is controlled to be increased in step S403 prior to starting combustion of the starting fuel by the starting burner BS in step S404.

Since the nitrogen gas supplied to the inert gas supply flow passage 81 by the air separation unit 80 is supplied to the combustor burner 10f, the combustion gas generated by combustion of the starting fuel is mixed with the nitrogen gas in the combustor 10d to thereby be the mixed gas whose oxygen concentration is lower than the combustion gas.

As described above, according to the starting step of the integrated gasification combined cycle facility 1 of the embodiment, since a period when the combustion gas is passed through the porous filter 32 can be secured for a longer time compared with a starting method of the Comparative Example, the time required for the porous filter 32 to be set to be not less than the predetermined temperature (for example, approximately 160° C.) can be reduced.

In addition, the oxygen concentration contained in the mixed gas is set to be low, whereby it can be suppressed that the sulfur content contained in the gas supplied to the porous filter 32 is oxidized to generate SO₂, SO₂ is converted into SO₃ by oxidization, and that thereby eventually corrosion occurs due to the sulfur contents.

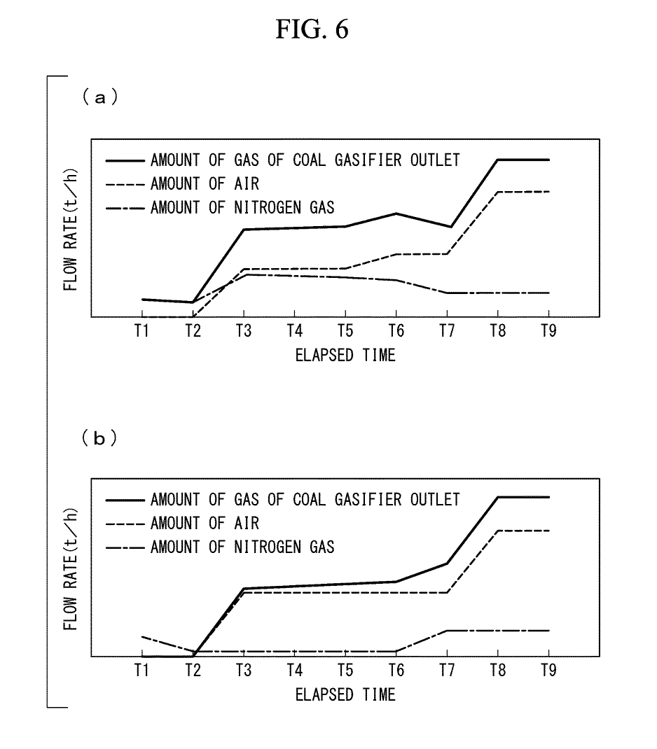

Next, using FIGS. 6(a) and 6(b), there will be explained flow rates of gas discharged from the char recovery unit 30 in the starting step of the integrated gasification combined cycle facility 1 of the embodiment, and the Comparative Example thereof.

In FIGS. 6(a) and 6(b), FIG. 6(a) shows the flow rate of the gas in the starting step of the embodiment, and FIG. 6(b) shows the flow rate of the gas in a starting step of the Comparative Example. Continuous lines in FIGS. 6(a) and 6(b) each show an amount of gas supplied from an outlet of the coal gasifier 10 to the combustible gas supply flow passage 11, broken lines each show an amount of air supplied to the coal gasifier 10, and alternate long and short dash lines each show an amount of nitrogen gas supplied to the coal gasifier 10.

First, the starting method of the embodiment of FIG. 6(a) will be explained. Step S401 of FIG. 4 corresponds to times T1 to T2 of FIG. 6(a). Supply of the nitrogen gas to the coal gasifier 10 is started at the time T1, and the flow rate of the nitrogen gas supplied to the coal gasifier 10 is maintained to be substantially constant until the time T2.

Step S402 of FIG. 4 corresponds to times T2 to T3 of FIG. 6(a).

Step S403 of FIG. 4 corresponds to times T2 to T7 of FIG. 6(a). The amount of nitrogen gas supplied from the air separation unit 80 to the inert gas supply flow passage 81 rises from the time T2 to the time T3, and the amount of nitrogen gas supplied to the coal gasifier 10 is maintained to be substantially constant from the time T3 to the time T6.

Step S404 of FIG. 4 corresponds to times T2 to T7 of FIG. 6(a). From the time T2 to the time T3, the opening of the air flow rate adjustment valve 56 is increased, and the amount of air supplied from the extracted air booster 54 to the coal gasifier 10 is increased. The amount of air supplied to the coal gasifier 10 is maintained to be substantially constant from the time T3 to the time T6.

When the control unit CU confirms that the amount of nitrogen gas and the amount of air have reached target amounts at the time T3, it supplies the starting fuel to the starting burner BS at time T4, and starts combustion by the starting fuel. The control unit CU continues combustion by the starting fuel while appropriately changing various conditions from the time T4 to the time T7.

Step S405 of FIG. 4 corresponds to times T7 to T8 of FIG. 6(a). At the time T7, the control unit CU outputs the control signal to increase the opening of the air flow rate adjustment valve 56, and the control signal to decrease the opening of the pressure adjustment valve 97. Hereby, from the time T7 to the time T8, the amount of air supplied to the coal gasifier 10 is increased, and the coal gasifier 10 is pressurized.

Step S406 of FIG. 4 corresponds to a time T9 of FIG. 6(a). The control unit CU confirms at the time T8 that the coal gasifier 10 has been pressurized to a target pressure, and ends ramping (pressurization). The control unit CU sets the opening and closing valves 92, 36, and 42 to be the closed state, and sets the opening and closing valves 12, 35, and 43 to be the opened state so that the combustion gas from which the char has been recovered by the char recovery unit 30 may be supplied to the gas purification equipment 40 at the time T9.

Subsequently, the starting method of the Comparative Example of FIG. 6(b) will be explained. Step S501 of FIG. 5 corresponds to times T1 to T2 of FIG. 6(b). Supply of the nitrogen gas to the coal gasifier 10 is started at the time T1, and a flow rate of an amount of nitrogen gas supplied to the coal gasifier 10 is gradually decreased until the time T2.

Step S502 of FIG. 5 corresponds to times T2 to T3 of FIG. 6(b).

Step S503 of FIG. 5 corresponds to times T2 to T7 of FIG. 6(b). From the time T2 to the time T3, the opening of the air flow rate adjustment valve 56 is increased, and the amount of air supplied from the extracted air booster 54 to the coal gasifier 10 is increased. The amount of air supplied to the coal gasifier 10 is maintained to be substantially constant from the time T3 to the time T6.

When the control unit CU confirms that the amount of air has reached a target amount at the time T3, it supplies the starting fuel to the starting burner BS at time T4, and starts combustion by the starting fuel. The control unit CU continues combustion by the starting fuel while appropriately changing various conditions from the time T4 to the time T7.

Step S505 of FIG. 5 corresponds to times T7 to T8 of FIG. 6(b). At the time T7, the control unit CU outputs the control signal to increase the opening of the air flow rate adjustment valve 56, and the control signal to decrease the opening of the pressure adjustment valve 97. Hereby, from the time T7 to the time T8, the amount of air supplied to the coal gasifier 10 is increased, and the coal gasifier 10 is pressurized.

Step S506 of FIG. 5 corresponds to a time T9 of FIG. 6(b). The control unit CU confirms at the time T8 that the coal gasifier 10 has been pressurized to a target pressure, and ends ramping (pressurization). The control unit CU sets the opening and closing valves 92, 36, and 42 to be the closed state, and sets the opening and closing valves 12, 35, and 43 to be the opened state so that the combustion gas from which the char has been recovered by the char recovery unit 30 may be supplied to the gas purification equipment 40 at the time T9.

As described above, in the starting step of the embodiment shown in FIG. 6(a), a supply amount of the nitrogen gas is increased from the time T2 prior to starting combustion by the starting fuel at the time T4, the supply amount of the nitrogen gas is made to reach the target amount at the time T3, and after that, combustion by the starting fuel is started.

In contrast with that, in the starting step of the Comparative Example, an amount of nitrogen gas supplied to the coal gasifier 10 remains a small one at the time of starting combustion by the starting fuel start at the time T4.

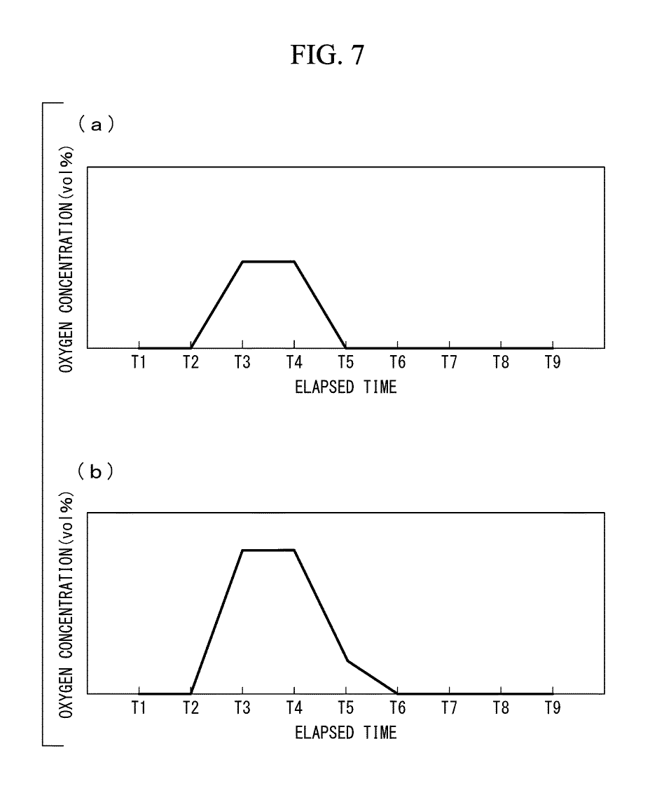

Next, using FIGS. 7(a) and 7(b), there will be explained oxygen concentrations of mixed gas discharged from the coal gasifier 10 in the starting step of the integrated gasification combined cycle facility 1 of the embodiment, and the Comparative Example thereof.

In FIGS. 7(a) and 7(b), FIG. 7(a) shows the oxygen concentration of the mixed gas discharged from the coal gasifier 10 in the starting step of the embodiment, and FIG. 7(b) shows the oxygen concentration of the mixed gas discharged from the coal gasifier 10 in the starting step of the Comparative Example.

When FIG. 7(a) and FIG. 7(b) are compared with each other, they are common in a point where the oxygen concentrations are maximum values at times T3 to T4. This is because supply of air to the coal gasifier 10 is started at the time T2, and has reached a constant flow rate at the time T3. In addition, this is because since combustion by the starting fuel is started at the time T4, oxygen is consumed by the combustion after the time T4.

Meanwhile, when FIG. 7(a) and FIG. 7(b) are compared with each other, they differ in a point where a maximum value of the oxygen concentration of FIG. 7(a) is smaller than that of FIG. 7(b). This is because in the starting step of the embodiment, the supply amount of the nitrogen gas is increased at the time T2 prior to starting combustion by the starting fuel at the time T4, and thereby the oxygen concentration of the mixed gas in which the nitrogen gas and the air have been mixed is decreased.

As described above, in the starting step of the embodiment, an oxygen concentration of an atmosphere around the starting burner BS at the time of starting combustion by the starting fuel is sufficiently lower compared with the starting step of the Comparative Example. Therefore, the oxygen concentration of the mixed gas of the combustion gas and the nitrogen gas that are supplied to the char recovery unit 30 can be set to be sufficiently low, and ignition of the unburned solid carbonaceous fuel contained in the char present in the char recovery unit 30 can be suppressed.

Next, actions and effects exerted by the coal gasification unit 100 of the embodiment will be explained.

The coal gasification unit 100 of the embodiment burns the oxygen-containing gas and the starting fuel using the starting burner BS in order to start the coal gasification unit 100. Combustion gas generated by combustion of the oxygen-containing gas and the starting fuel is then supplied to the char recovery unit 30. By configuring the coal gasification unit 100 as described above, after the char contained in the oxygen-containing gas and the combustion gas is recovered by the char recovery unit 30, the gas from which the char has been recovered is supplied to the flare equipment 90. Hereby, the oxygen-containing gas and the combustion gas containing the char can be prevented or suppressed from being supplied to the flare equipment 90.

Here, since the char containing unburned solid carbonaceous fuel is present in the char recovery unit 30, the unburned solid carbonaceous fuel contained in the char may be ignited in a case where an oxygen concentration of the combustion gas supplied to the char recovery unit 30 is high.

Consequently, in the coal gasification unit 100 of the embodiment, a supply amount of nitrogen gas (inert gas) supplied to the upstream side of the char recovery unit 30 is controlled prior to starting combustion of the starting fuel by the starting burner BS, and the oxygen concentration of the mixed gas in which the combustion gas generated by combustion of the oxygen-containing gas and the starting fuel has been mixed with the nitrogen gas is set to be not more than the ignition concentration.

By configuring the coal gasification unit 100 as described above, even in a case where the oxygen concentration of the combustion gas generated by combustion of the oxygen-containing gas and the starting fuel is high, the nitrogen gas is mixed with the combustion gas on the upstream side of the char recovery unit 30, and the mixed gas having the oxygen concentration not more than the ignition concentration is supplied to the char recovery unit 30. Therefore, ignition of the unburned solid carbonaceous fuel contained in the char present in the char recovery unit 30 can be suppressed.

Further, since the supply amount of the nitrogen gas (the inert gas) supplied to the upstream side of the char recovery unit 30 is controlled prior to starting the combustion of the starting fuel by the starting burner BS, the combustion gas to be generated is more reliably mixed with the nitrogen gas (the inert gas) from the time of generation of the combustion gas, and thereby the oxygen concentration of the mixed gas in which the combustion gas and the nitrogen gas have been mixed never becomes high, resulting in an effect of more reliably decreasing the oxygen concentration.

The coal gasification unit 100 of the embodiment is desirably configured such that the ignition concentration is lower than the lower-limit value of the oxygen concentration at which the unburned solid carbonaceous fuel contained in the char present in the char recovery unit 30 can be ignited.

By configuring the coal gasification unit 100 as described above, ignition of the unburned solid carbonaceous fuel contained in the char present in the char recovery unit 30 can be reliably prevented.

In addition, the ignition concentration is preferably 14 volume percent concentration.

The present inventors have found out that ignition of the unburned solid carbonaceous fuel can be prevented by reliably setting the oxygen concentration to be not more than a prescribed concentration from generation start of the combustion gas including the time of gasifier ignition by the starting fuel without needing to set the oxygen concentration of the mixed gas containing the combustion gas to be completely zero.

Namely, the present inventors have obtained knowledge that in a case where a concentration of coal dust contained in the combustion gas is comparatively low, and where the pressure in the coal gasifier 10 at the time of start is comparatively low with respect to the steady operation pressure, ignition of the unburned solid carbonaceous fuel present in the char recovery unit 30 can be prevented by setting the oxygen concentration of the mixed gas to be not more than 14 volume percent concentration. Accordingly, ignition of the unburned solid carbonaceous fuel can be prevented by setting the oxygen concentration of the mixed gas to be not more than 14 volume percent concentration.

In addition, the ignition concentration is more preferably 12 volume percent concentration.

The present inventors have obtained knowledge that in a case where the pressure in the coal gasifier 10 at the time of start is comparatively low with respect to the steady operation pressure, ignition of the unburned solid carbonaceous fuel can be reliably prevented by setting the oxygen concentration of the mixed gas to be not more than 12 volume percent concentration regardless of the concentration of the coal dust contained in the combustion gas. Accordingly, ignition of the unburned solid carbonaceous fuel can be reliably prevented by setting the oxygen concentration of the mixed gas to be not more than 12 volume percent concentration.

As described above, from start to end, the oxygen concentration of the mixed gas is set to be not more than 14 volume percent concentration in an atmospheric pressure level, and it is set to be not more than 12 volume percent concentration in a high-pressure state, whereby ignition of the unburned solid carbonaceous fuel can be prevented.

Here, “ignition” means that catching fire occurs by presence of a heat source etc., to thereby generate a combustion reaction, and it is different from an oxidation reaction that gradually proceeds. In addition, a generation state of flames differs depending on an amount and a state of the unburned solid carbonaceous fuel, and ignition is not necessarily the same as firing happening by itself. Ignition of the unburned solid carbonaceous fuel contained in the char present in the char recovery unit 30 can be suppressed, and thereby it is prevented that combustion heat due to combustion of the solid carbonaceous fuel excessively raises a temperature of the char recovery unit 30, and that the excessive rise of the temperature causes a design temperature excess and damage of a material.

In the coal gasification unit 100 of the embodiment, the coal gasifier 10 has the combustor burner 10f that burns the pulverized coal, and the air separation unit 80 supplies the nitrogen gas to the combustor burner 10f through the inert gas supply flow passage 81.

By configuring the coal gasification unit 100 as described above, the nitrogen gas can be mixed with the combustion gas generated by combustion of the oxygen-containing gas and the starting fuel, using the combustor burner 10f used to burn the pulverized coal at the time of operation of the coal gasification unit 100.

In the embodiment, the coal gasifier 10 has the plurality of combustor burners 10f, and blow-off ports of the plurality of combustor burners 10f are arranged toward different directions, respectively so that the gas discharged from the blow-off ports may form a center of a vortex substantially in a direction perpendicular to a gasifier cross section.

By configuring the coal gasification unit 100 as described above, the vortex is formed by the nitrogen gas discharged from the combustor burners 10f to the coal gasifier 10, and mixing of the combustion gas generated by combustion of the oxygen-containing gas and the starting fuel with the inert gas is promoted. Accordingly, a portion with a high oxygen concentration is not present in the mixed gas, and ignition of the unburned solid carbonaceous fuel can be suppressed.

### Second Embodiment

Next, a second embodiment of the present invention will be explained. The embodiment is a Modified Example of the first embodiment, and shall be similar to the first embodiment unless otherwise particularly explained hereinafter, and thus explanation of similar points is omitted.

In the first embodiment of the present invention, the air separation unit 80 supplies the nitrogen gas to the combustor burner 10f, prior to starting combustion of the oxygen-containing gas and the starting fuel by the starting burner BS.

In contrast with that, in the embodiment, the nitrogen gas from the air separation unit 80 is supplied to the annulus section 10j located on a downstream side of the combustor burner 10f and on an upstream side of the combustible gas supply flow passage 11 instead of being supplied to the combustor burner 10f.

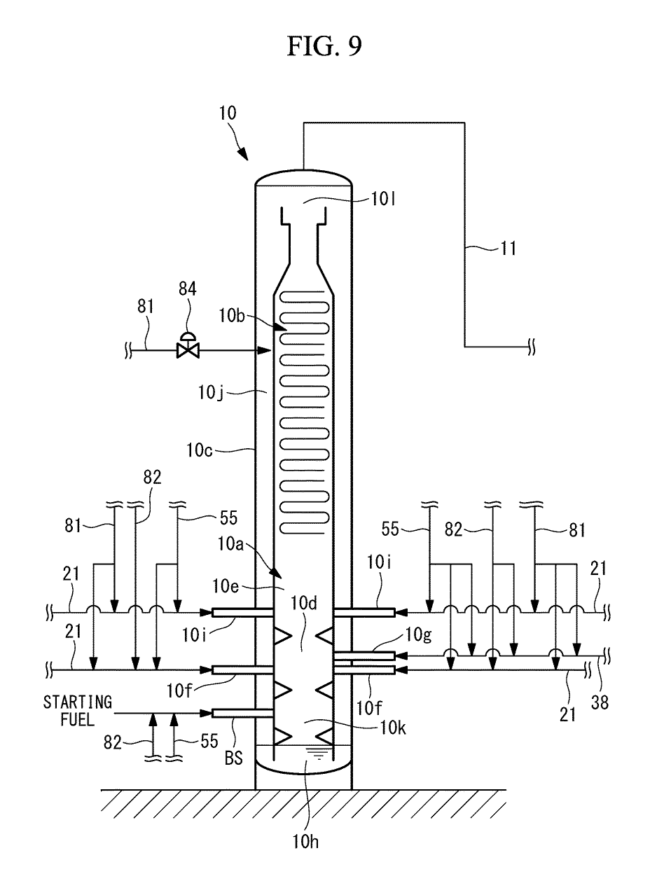

As shown in FIG. 9, in the embodiment, a flow rate adjustment valve 84 is provided in the inert gas supply flow passage 81 that supplies the nitrogen gas from the air separation unit 80 to the coal gasifier 10, and the control unit CU controls an opening of the flow rate adjustment valve 84.

As shown in FIG. 9, a place to which the nitrogen gas is supplied through the flow rate adjustment valve 84 is the annulus section 10j. The nitrogen gas supplied to the annulus section 10j is mixed with the combustion gas that has passed through the syngas cooler 10b at an outlet portion 101 of the syngas cooler 10b. That is, the nitrogen gas supplied through the flow rate adjustment valve 84 is mixed with the combustion gas in which heat exchange has been performed by the syngas cooler 10b.

According to the integrated gasification combined cycle facility of the embodiment, heat recovery efficiency of the syngas cooler 10b can be more improved compared with a case where the nitrogen gas is supplied to the upstream side of the syngas cooler 10b to thereby decrease the temperature of the combustion gas.

### Third Embodiment

Next, a third embodiment of the present invention will be explained. The embodiment is a Modified Example of the first embodiment, and shall be similar to the first embodiment unless otherwise particularly explained hereinafter, and thus explanation of similar points is omitted.

In the first embodiment of the present invention, the air separation unit 80 supplies the nitrogen gas to the combustor burner 10f, prior to starting combustion of the oxygen-containing gas and the starting fuel by the starting burner BS.

In contrast with that, in the embodiment, the nitrogen gas is supplied to the combustible gas supply flow passage 11 through which the combustible gas is supplied from the coal gasifier 10 to the char recovery unit 30, instead of being supplied to the combustor burner 10f.

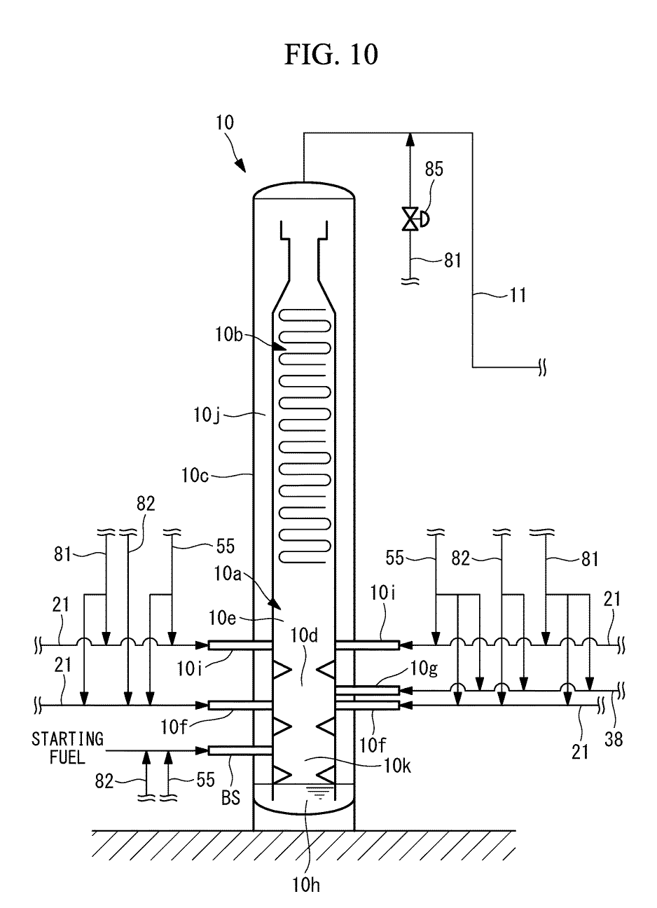

As shown in FIG. 10, in the embodiment, a flow rate adjustment valve 85 is provided in the inert gas supply flow passage 81 that supplies the nitrogen gas from the air separation unit 80 to the combustible gas supply flow passage 11, and the control unit CU controls an opening of the flow rate adjustment valve 85.

According to the integrated gasification combined cycle facility of the embodiment, the nitrogen gas can be supplied to the upstream side of the char recovery unit 30 even without affecting the coal gasifier 10, and the nitrogen gas can be mixed with the combustion gas generated by combustion of the oxygen-containing gas and the starting fuel.

### Fourth Embodiment

In the second embodiment of the present invention, the nitrogen gas is supplied to the annulus section 10j located on the downstream side of the combustor burner 10f and on the upstream side of the combustible gas supply flow passage 11 instead of the combustor burner 10f in the first embodiment. In addition, in the third embodiment of the present invention, the nitrogen gas is supplied to the combustible gas supply flow passage 11 through which the combustible gas is supplied from the coal gasifier 10 to the char recovery unit 30 instead of the combustor burner 10f in the first embodiment.

In contrast with that, in the embodiment, in addition to the combustor burner 10f in the first embodiment, the nitrogen gas is supplied to the outlet portion 101 located on the downstream side of the syngas cooler 10b and on the upstream side of the combustible gas supply flow passage 11, or the nitrogen gas is further supplied to the combustible gas supply flow passage 11 through which the combustible gas is supplied from the coal gasifier 10 to the char recovery unit 30.

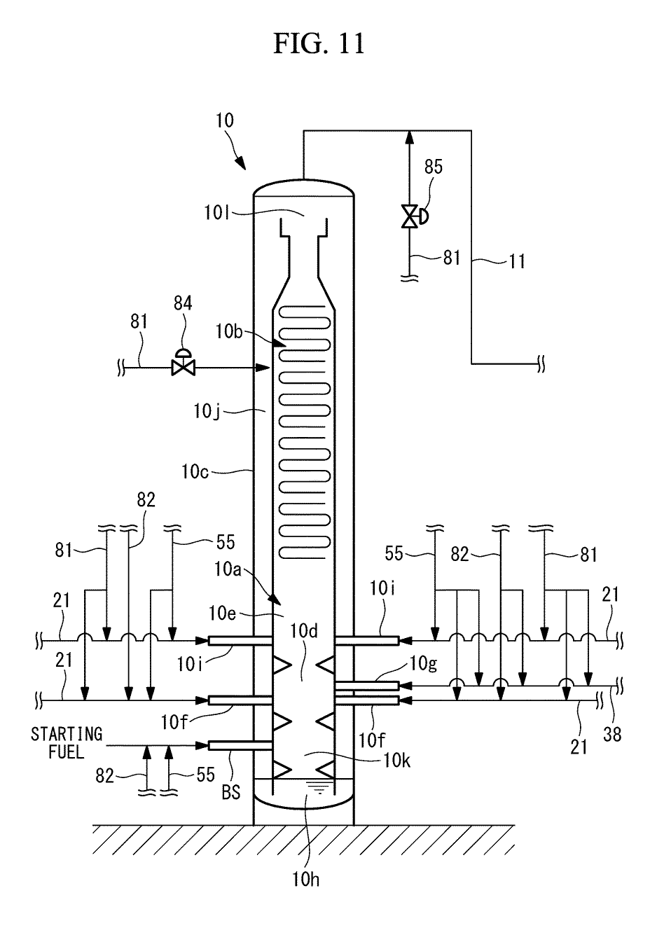

As shown in FIG. 11, the integrated gasification combined cycle facility of the embodiment includes the flow rate adjustment valve 84 that supplies the nitrogen gas from the air separation unit 80 to the outlet portion 101 of the syngas cooler 10b located on the downstream side of the syngas cooler 10b and on the upstream side of the upstream side of the combustible gas supply flow passage 11.

In addition, the integrated gasification combined cycle facility 1 of the embodiment includes the flow rate adjustment valve 85 that supplies the nitrogen gas from the air separation unit 80 to the combustible gas supply flow passage 11.

As described above, the integrated gasification combined cycle facility of the embodiment is configured such that the nitrogen gas supplied from the inert gas supply flow passage can be supplied to respective places from the combustor burner 10f, the flow rate adjustment valve 84, and the flow rate adjustment valve 85.

Additionally, the control unit CU of the embodiment can appropriately control which of the combustor burner 10f, the flow rate adjustment valve 84, and the flow rate adjustment valve 85 the nitrogen gas is supplied to. In addition, the control unit CU can appropriately control how much amount of nitrogen gas should be supplied to each of the combustor burner 10f, the flow rate adjustment valve 84, and the flow rate adjustment valve 85.

Specifically, a distribution device (illustration is omitted) that distributes the nitrogen gas to each of the combustor burner 10f, the flow rate adjustment valve 84, and the flow rate adjustment valve 85 is provided in the inert gas supply flow passage 81. Additionally, the control unit CU appropriately controls which of the combustor burner 10f, the flow rate adjustment valve 84, and the flow rate adjustment valve 85 the nitrogen gas is supplied to by controlling the distribution device. In addition, the control unit CU decides a distribution amount of the nitrogen gas to be distributed to each of the combustor burner 10f, the flow rate adjustment valve 84, and the flow rate adjustment valve 85 by controlling the distribution device.

According to the embodiment, the nitrogen gas is supplied to a plurality of places of the upstream side of the char recovery unit 30, and thereby mixed gas having a higher degree of mixing and uniformed oxygen concentration distribution can be generated, and can be supplied to the char recovery unit 30.

### Other Embodiments

In the above explanation, although there has been shown the examples using the coal gasifier 10 that gasifies the pulverized coal as equipment for generating combustible gas, other aspects may be employed.

For example, as the equipment for generating the combustible gas, gasification unit may be used that gasifies other solid carbonaceous fuel, for example, biomass fuel, such as thinnings, scrap wood, driftwood, grass, waste, sludge, and tires.

In the above explanation, although both the gas turbine equipment 50 and the steam turbine equipment 70 give drive forces to the rotation shaft coupled to the generator 71, other aspects may be employed. For example, a generator exclusively for the gas turbine equipment 50 may be provided at the rotation shaft to which the gas turbine equipment 50 gives the drive force, and a generator exclusively for the steam turbine equipment 70 may be provided at the rotation shaft to which the steam turbine equipment 70 gives the drive force.

In the above explanation, although nitrogen gas is exemplified as inert gas (inactive gas), other aspects may be employed. For example, other inert gas, such as carbon dioxide or mixed gas of carbon dioxide and nitrogen, may be employed instead of the nitrogen gas.

### REFERENCE SIGNS LIST

1 integrated coal gasification combined cycle facility
10 coal gasifier (gasifier)
10a gasification section
10b syngas cooler (heat exchanger)
10d combustor
10f combustor burner
10j annulus section
10k starting combustion chamber
101 outlet portion
11, 34, and 41 combustible gas supply flow passage
12, 35, 36, 42, 43, and 92 opening and closing valve
21 pulverized fuel supply flow passage
30 char recovery unit
31 cyclone
32 porous filter
40 gas purification equipment
50 gas turbine equipment
54 extracted air booster
55 air supply flow passage
56 air flow rate adjustment valve (first supply section)
60 exhaust heat recovery boiler (HRSG)
70 steam turbine equipment (ST)
80 air separation unit (ASU)
81 inert gas supply flow passage (second supply section)
82 oxygen supply flow passage (first supply section)
84 and 85 flow rate adjustment valve
90 flare equipment
100 coal gasification unit (gasification unit)
BS starting burner
CU control unit (control section)

1. Gasification unit comprising:
a gasifier that gasifies solid carbonaceous fuel using oxygen-containing gas, and generates combustible gas;
a char recovery unit that recovers char contained in the combustible gas generated by the gasifier;
flare equipment that burns the combustible gas from which the char has been recovered by the char recovery unit;
a first supply section that supplies the oxygen-containing gas to the gasifier;
a second supply section that supplies inert gas to an upstream side of the char recovery unit; and
a control section that controls a supply amount of the oxygen-containing gas supplied by the first supply section and a supply amount of the inert gas supplied by the second supply section, wherein
the gasifier has a starting burner that burns starting fuel using the oxygen-containing gas supplied from the first supply section, and wherein
the control section controls the supply amount of the inert gas supplied by the second supply section prior to starting combustion of the starting fuel by the starting burner, and sets an oxygen concentration of mixed gas in which combustion gas generated by combustion of the oxygen-containing gas and the starting fuel by the starting burner has been mixed with the inert gas supplied by the second supply section to be not more than an ignition concentration lower than a lower-limit value of an oxygen concentration at which unburned solid carbonaceous fuel contained in char present in the char recovery section can be ignited.

2. (canceled)

3. The gasification unit according to claim 1, wherein the ignition concentration is 14 volume percent concentration.

4. The gasification unit according to claim 1, wherein the ignition concentration is 12 volume percent concentration.

5. The gasification unit according to claim 1, wherein
the gasifier has a combustor burner that burns the solid carbonaceous fuel, and wherein
the second supply section supplies the inert gas to the combustor burner.

6. The gasification unit according to claim 5, wherein
the gasifier has the plurality of combustor burners, and wherein
blow-off ports of the plurality of combustor burners are arranged toward different directions, respectively so that gas discharged from the blow-off ports forms a vortex.

7. The gasification unit according to claim 1, wherein
the gasifier has a heat exchanger that generates steam by heat exchange of the combustible gas and water, and wherein
the second supply section supplies the inert gas to a downstream side of the heat exchanger, and to an upstream side of a combustible gas supply flow passage through which the combustible gas is supplied from the gasifier to the char recovery unit.

8. The gasification unit according to claim 1, wherein the second supply section supplies the inert gas to the combustible gas supply flow passage through which the combustible gas is supplied from the gasifier to the char recovery unit.

9. An integrated gasification combined cycle facility comprising:
the gasification unit according to claim 1;
gas turbine equipment that is operated using as fuel the combustible gas generated by the gasification unit;
an exhaust heat recovery boiler that recovers heat in combustion exhaust gas generated by combustion of the combustible gas by the gas turbine equipment to thereby generate steam;
steam turbine equipment that is operated by the steam supplied from the exhaust heat recovery boiler; and
a generator that is driven by power supplied by the gas turbine equipment and power supplied by the steam turbine equipment.

10. A method for starting gasification unit including: a gasifier in which combustible gas is generated by gasifying solid carbonaceous fuel using oxygen-containing gas; a char recovery unit that recovers char contained in the combustible gas generated by the gasifier; flare equipment that burns the combustible gas from which the char has been recovered by the char recovery unit; a first supply section that supplies the oxygen-containing gas to the gasifier; and a second supply section that supplies inert gas to an upstream side of the char recovery unit, the method comprising:
a control step of controlling a supply amount of the inert gas supplied by the second supply section; and
a starting combustion step of burning the oxygen-containing gas and starting fuel by a starting burner to thereby generate combustion gas, wherein
the control step controls the supply amount of the inert gas supplied by the second supply section prior to the starting combustion step, and sets an oxygen concentration of mixed gas in which the combustion gas generated by the starting combustion step has been mixed with the inert gas supplied by the second supply section to be not more than an ignition concentration lower than a lower-limit value of an oxygen concentration at which unburned solid carbonaceous fuel contained in char present in the char recovery section can be ignited.

11. (canceled)

12. The method for starting the gasification unit according to claim 10, wherein the ignition concentration is 14 volume percent concentration.

13. The method for starting the gasification unit according to claim 10, wherein the ignition concentration is 12 volume percent concentration.
